(19) United States
(12) Patent Application Publication
(10) Pub. No.: US 2009/0084681 A1
(43) Pub. Date: Apr. 2, 2009

(54) MULTILAYER BODY FOR ELECTROPHORESIS AND TRANSFER, CHIP FOR ELECTROPHORESIS AND TRANSFER, ELECTROPHORESIS AND TRANSFER APPARATUS, METHOD OF ELECTROPHORESIS AND TRANSFER, AND METHOD OF MANUFACTURING MULTILAYER BODY FOR ELECTROPHORESIS AND TRANSFER

(76) Inventors: Satonari AKUTSU, Tokyo (JP); Koji Sakairi, Tokyo (JP); Atsunori Hiratsuka, Tokyo (JP); Hideki Kinoshita, Tokyo (JP); Kenji Yokoyama, Tsukuba-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/237,816

(22) Filed: Sep. 25, 2008

(30) Foreign Application Priority Data
Sep. 27, 2007 (JP) 2007-251358

(51) Int. Cl. B01D 61/42; B05D 5/12

(52) U.S. Cl. 204/518; 204/627; 427/58

(57) ABSTRACT

With the use of a chip (4) for electrophoresis and transfer including a transfer membrane (1) and an electrophoretic gel that is integrated with the transfer membrane (1), separation of a sample by electrophoresis and transfer of the sample separated to the transfer membrane (1) are carried out consecutively. This allows molecules separated on the gel by electrophoresis to be accurately transferred to the transfer membrane.

This Nonprovisional application claims priority under U.S.C. §119(a) on Patent Application No. 251,358/2007 filed in Japan on Sep. 27, 2007, the entire contents of which are hereby incorporated by reference.

### FIELD OF THE INVENTION

The present invention relates to a multilayer body for electrophoresis and transfer, a chip for electrophoresis and transfer, an electrophoresis and transfer apparatus, a method of electrophoresis and transfer, and a method of manufacturing a multilayer body for electrophoresis and transfer. More specifically, the present invention relates to a multilayer body for electrophoresis and transfer, a chip for electrophoresis and transfer, an electrophoresis and transfer apparatus, a method of electrophoresis and transfer, and a method of manufacturing a multilayer body for electrophoresis and transfer, each including an electrophoresis support and a transfer medium.

### BACKGROUND OF THE INVENTION

An electrophoresis technology in which biopolymers, such as DNA, RNA, and protein, extracted from tissues or cells of plants and animals are separated on an electrophoretic gel based on differences in size, property, or the like is an extremely important technology in a life science field. Especially, in a case where protein is separated by electrophoresis, two-dimensional electrophoresis that is carried out by a combination of SDS-polyacrylamide gel electrophoresis that is carried out based on molecular weight of protein and isoelectric focusing electrophoresis that is carried out based on a difference in isoelectric points has been widely used.

Moreover, in a case where biopolymers separated by use of the electrophoresis technology are further analyzed, the separated biopolymers are transferred from an electrophoretic gel to a transfer membrane, so that genetic engineering or immunochemical analysis is carried out on the transfer membrane by use of hybridization, antigen-antibody reaction, and the like. In this case, in order that the biopolymers separated on the electrophoretic gel are transferred to the transfer membrane after the electrophoresis is completed, the gel is taken out from an electrophoresis apparatus after the electrophoresis, and attached to the transfer membrane. Then, the gel thus attached to the transfer membrane is placed in a transfer apparatus, so that molecules in the gel are absorbed by the transfer membrane.

In this way, the method in which biopolymers are separated on an electrophoretic gel and transferred to a transfer membrane has been widely used, and variously modified depending on purposes of analysis. Japanese Translation of PCT international application, Tokuhyo, No. 2004-518949 (published on Jun. 24, 2004) discloses that plural transfer membranes that are layered are laminated on a gel after electrophoresis, and biopolymers separated on the gel are transferred to the layered transfer membranes, so that the biopolymers thus separated are transferred to the plural transfer membranes. This makes it possible to carry out different analysis with respect to each of the transfer membranes to which molecules are transferred, which allows analysis according to properties of each separated molecule.

### SUMMARY OF THE INVENTION

However, in a conventional arrangement, it is required that (i) a gel be taken out from an electrophoresis apparatus after electrophoresis is completed, and (ii) a transfer membrane be attached on the gel thus taken out. In the arrangement disclosed in Japanese Translation of PCT international application, Tokuhyo, No. 2004-518949, the gel is taken out from the electrophoresis apparatus after electrophoresis is completed, and a plurality of membranes are superimposed on the gel thus taken out. Such a case may cause a problem that the gel is distorted or damaged when the gel is taken out, or a problem that a separation pattern on the gel becomes inaccurate. Further, when the transfer membrane is attached on the gel, air bubbles may come between the gel and the transfer membrane. These problems cause difficulties in precisely transferring molecules separated on the gel to the transfer membranes.

The present invention is accomplished in view of the above problem. An object of the present invention is to provide a multilayer body for electrophoresis and transfer, which makes it possible to precisely transfer molecules separated on a gel by electrophoresis to a transfer membrane.

In order to achieve the object, a multilayer body of the present invention for electrophoresis and transfer includes a transfer medium and an electrophoresis support that is integrated with the transfer medium.

A chip of the present invention for electrophoresis and transfer medium includes the multilayer body for electrophoresis and transfer.

An electrophoresis and transfer apparatus of the present invention which electrophoreses and transfers a target material to be separated, by use of the multilayer body for electrophoresis and transfer or the chip for electrophoresis and transfer, the apparatus includes: separation means for separating the target material on the electrophoresis support; and transfer means for transferring the target material thus separated on the electrophoresis support to the transfer medium.

A method for electrophoresing and transferring a target material to be separated, by use of the multilayer body for electrophoresis and transfer or the chip for electrophoresis and transfer, the method includes the steps of: (a) separating the target material on the electrophoresis support and (b) subsequently to the step (a), transferring the target material thus separated on the electrophoresis support to the transfer medium.

A method of the present invention for manufacturing a multilayer body for electrophoresis and transfer includes the step of forming the electrophoresis support by filling a material of the electrophoresis support onto the transfer medium.

In the arrangement, the multilayer body for electrophoresis and transfer is such that the transfer medium is superimposed on the electrophoresis support so as to form a coherent multilayer body structure, so that a gas does not come between the transfer medium and the electrophoresis support. This makes it possible to consecutively carry out separation of a target material by electrophoresis and transfer of the target material thus separated, and avoids troubles that are caused when the transfer medium is attached to the electrophoresis support. As a result, a separation pattern of a sample can be precisely transferred. Further, electrophoresis and transfer with the use of such a multilayer body for electrophoresis and transfer can facilitate processes in electrophoresis and transfer, which can reduce process time.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a view schematically illustrating processes of forming a chip of an embodiment of the present invention for electrophoresis and transfer, and carrying out electrophoresis and transfer.

FIG. 2 shows results of transferring samples by use of chips of one embodiment of the present invention for electrophoresis and transfer, after electrophoresis is completed.

FIG. 3 shows results of transferring samples by use of chips of one embodiment of the present invention and chemically staining the samples.

FIG. 4 shows results of transferring samples by use of a chip of one embodiment of the present invention for electrophoresis and transfer and immunostaining the samples.

FIG. 5 shows results of transferring samples by use of a chip of one embodiment of the present invention for electrophoresis and transfer and immunostaining the samples.

FIG. 6 shows results of transferring samples by use of chips of one embodiment of the present invention for electrophoresis and transfer and chemically staining the samples.

FIG. 7 shows results of transferring samples by use of chips of one embodiment of the present invention for electrophoresis and transfer and chemically staining the samples.

FIG. 8 shows results of carrying out electrophoresis with respect to samples by use of chips of one embodiment of the present invention for electrophoresis and transfer.

FIG. 9 shows results of transferring samples by use of chips of one embodiment of the present invention for electrophoresis and transfer.

FIG. 10 shows results of carrying out electrophoresis with respect to samples by use of chips of one embodiment of the present invention for electrophoresis and transfer.

FIG. 11 shows results of transferring samples by use of chips of one embodiment of the present invention for electrophoresis and transfer.

FIG. 12 shows results of carrying out electrophoresis with respect to samples by use of chips of one embodiment of the present invention for electrophoresis and transfer.

FIG. 13 shows results of transferring samples by use of chips of one embodiment of the present invention for electrophoresis and transfer.

### DESCRIPTION OF THE EMBODIMENTS

(Multilayer Body for Electrophoresis and Transfer)

A multilayer body of the present invention for electrophoresis and transfer includes a transfer medium and an electrophoresis support that is integrated with the transfer medium. The multilayer body for electrophoresis and transfer is used for separating, by electrophoresis, a target material to be separated on the electrophoresis support, and transferring the target material thus separated to the transfer medium. In the multilayer body for electrophoresis and transfer according to the present invention, the transfer medium is superimposed on the electrophoresis support so as to form a coherent multilayer body structure, so that a gas does not come between the transfer medium and the electrophoresis support.

The multilayer body of the present invention for electrophoresis and transfer can be formed by polymerizing a material of the electrophoresis support on the transfer medium. Here, it is preferable that the transfer medium be almost in the same shape of the electrophoresis support and an area of the transfer medium be almost the same as that of the electrophoresis support. Moreover, each thickness of the transfer medium and the electrophoresis support may be within a range of a general thickness that is regularly used for transfer or electrophoresis, and a thickness of the multilayer body for electrophoresis and transfer including the transfer medium and the electrophoresis support may be in a range of a thickness that allows electrophoresis and transfer by use of a conventional method or apparatus.

The multilayer body of the present invention for electrophoresis and transfer includes the transfer medium and the electrophoresis support that are integrated with each other. This makes it possible to consecutively separate, by electrophoresis, a target material to be separated and transfer the target material thus separated. In view of this, the multilayer body of the present invention for electrophoresis and transfer is used for the purpose of electrophoresis and transfer, and the multilayer body functions as an electrophoresis support and a transfer medium. Accordingly, the multilayer body of the present invention for electrophoresis and transfer can be also referred to as an electrophoresis support integrated with a transfer medium, or a transfer medium integrated with an electrophoresis support.

(Target Material to be Separated)

A target material to be separated that is separated by use of the multilayer body of the present invention for electrophoresis and transfer is a material that is to be analyzed by electrophoresis and transfer, and may be referred to as a sample. As the target material, a preparation obtained from a biological material (for example, a bion, a body fluid, a cell line, a cultured tissue, or a tissue fragment) can be preferably used, and especially, a protein sample, a DNA sample, and an RNA sample can be preferably used. These samples may be preliminarily stained by a fluorescent sample or the like (fluorescently-stained or fluorescently-labeled).

(Electrophoresis Support)

An electrophoresis support included in the multilayer body of the present invention for electrophoresis and transfer separates a target material on the support by electrophoresis based on difference in size, property, and the like of the target material, and may be also referred to as simply a support. The electrophoresis support is a gel in which polymerized molecules are formed in a complicated mesh structure so that the target material can move in the support. From this reason, the electrophoresis support may be referred to as simply a gel or an electrophoretic gel. As a main material for forming a gel, a gel material that is conventionally used for electrophoresis, such as polyacrylamide or agarose, can be preferably used.

In the multilayer body of the present invention for electrophoresis and transfer, the electrophoresis support is integrated with a transfer medium such that the electrophoresis support adheres tightly to the transfer medium. The electrophoresis support can be formed, for example, in such a manner that a gel solution containing a gel material of the electrophoresis support is filled onto a transfer medium, and the transfer medium filled with the gel solution is left to stand so that the gel solution is polymerized.

(Transfer Medium)

A transfer medium included in the multilayer body of the present invention for electrophoresis and transfer is the one to which a target material that has been separated on the electrophoresis support is transferred while maintaining a separation pattern on the support. Since a thin sheet-like film is generally used, the transfer medium may be referred to as simply a film, a transfer membrane, a membrane, or a filter. The transfer membrane encompasses, for example, a nitrocellulose membrane, a nylon membrane, a polyvinylidene-fluoride (PVDF) membrane, and the like, but not limited to these. A membrane to which a separation pattern of a target material can be transferred from an electrophoretic gel by a capillary method, an electroblotting method, and the like can be preferably used.

When the multilayer body of the present invention for electrophoresis and transfer is used, it is possible to consecutively separate a sample by electrophoresis and transfer the sample thus separated. Further, it is possible to avoid troubles that are caused when an electrophoresis support is attached to a transfer medium, and to precisely transfer a separation pattern of the sample.

Generally, after a sample is electrophoresed and a separation pattern of the sample on an electrophoretic gel is transferred to a transfer membrane, the sample adsorbed on the transfer membrane is further subjected to a genetic engineering analysis (for example, Southern blotting) or an immunochemical analysis (for example, Western blotting). When such an analysis is carried out, it is preferable that the transfer membrane to which the sample has been transferred be detached from the electrophoretic gel and the analysis is carried out by use of the transfer membrane thus detached. On this account, it is preferable that the transfer medium integrated with the electrophoresis support can be easily detached from the electrophoresis support after a sample is separated by use of the multilayer body of the present invention for electrophoresis and transfer and a separation pattern is precisely transferred to the transfer medium.

From this reason, in the multilayer body of the present invention for electrophoresis and transfer, it is preferable to use a polyolefin porous membrane containing a polyolefin resin as its main component, or a coated membrane that is coated with a water-soluble resin as the transfer medium that is integrated with the electrophoresis support. This heightens precision in transferring a separation pattern of a sample, and allows the transfer medium to which the sample has been transferred to be easily detached from the electrophoresis support. The transfer membrane does not disturb separation of the sample by electrophoresis and transfer of the sample separated. As a result, processes of electrophoresis, transfer, and preparation of analysis of the sample that has been transferred can be effectively and easily carried out.

(Polyolefin Porous Membrane)

A polyolefin porous membrane containing a polyolefin resin as its main component, which is used as a transfer medium, is mainly made of a polyolefin resin, and is a porous thin membrane that is capable of adsorbing a sample separated by electrophoresis from an electrophoresis support while maintaining a separation pattern, and fixing the sample. The polyolefin porous membrane may be, for example, a polyolefin porous membrane that is generally used as a separator for fuel battery and commercially available.

When the polyolefin porous membrane is prepared so as to be integrated with an electrophoresis support, it is possible that the membrane adheres tightly to the electrophoresis support, which allows (i) a separation pattern of a sample separated by electrophoresis to be sufficiently transferred to the membrane, and (ii) the membrane to which the sample has been transferred to be detached from the electrophoresis support. As has been already described, the polyolefin resin that is a main component of the polyolefin porous membrane can realize an arrangement in which the electrophoresis support adheres tightly to the membrane to an extent that (i) the sample can be sufficiently transferred from the electrophoresis support and (ii) the membrane can be detached from the electrophoresis support. From this reason, the polyolefin resin contained in the polyolefin porous membrane is preferably selected from the group consisting of polyethylene, polypropylene, poly(a-olefin), modified polyethylene, and modified polypropylene, but is not limited to these.

It is preferable that the polyolefin porous membrane be in a range of 0.2 to 0.5 μm in pore diameter. When the pore diameter is in the range, it is possible to sufficiently transfer a separation pattern of a target material to the polyolefin porous membrane from the electrophoresis support, and to fix the transferred separation pattern to the polyolefin porous membrane. On the other hand, when the polyolefin porous membrane is less than 0.2 μm in pore diameter, transfer of the sample is disturbed, thereby resulting in that a large amount of the sample remains in a gel and it is difficult to sufficiently transfer the sample from the electrophoretic gel. When the polyolefin porous membrane is more than 0.5 μm in pore diameter, it is difficult to fix the transferred sample to the membrane.

Moreover, it is preferable that the polyolefin porous membrane is not less than 5 μm in thickness. When the membrane is less than 5 μm in thickness, the sample passes through the membrane, so that the sample cannot be fixed to the membrane. Accordingly, the thickness of less than 5 μm is not preferable.

Here, if a target sample to be analyzed is preliminarily labeled (stained) by a fluorescent material or the like, it is possible to easily observe the sample after the sample is transferred. However, if the sample is not preliminarily labeled, the sample cannot be observed. In this case, it is necessary to stain the sample after the sample is transferred so that the sample can be observed. In view of this, considering a possibility of staining the sample after the sample is transferred, it is preferable that the polyolefin porous membrane be coated with nitrocellulose. Here, the coated membrane that is coated with nitrocellulose encompasses a membrane whose surface is coated with nitrocellulose (coating), a membrane whose surface and pores are coated with nitrocellulose, and a membrane that is impregnated with nitrocellulose. This makes it possible to stain a sample transferred onto a transfer membrane so that the sample can be observed. This does not prevent polymerization of a gel solution on the membrane, and easily forms a multilayer body for electrophoresis and transfer.

The method of staining a sample on the transfer membrane encompasses: a method of staining all molecules in a sample by use of artificial color or the like containing a fluorescent material (chemical staining); and a method of, with the use of a probe (DNA fragments or the like), an antibody, or the like which is fluorescently labeled, staining molecules that are specially combined therewith (hybridization, immunostaining, and the like).

The nitrocellulose coating of the polyolefin porous membrane can be realized, for example, by immersing the polyolefin porous membrane into a nitrocellulose solution containing nitrocellulose. In the nitrocellulose coating, at least a surface of the polyolefin porous membrane may be coated with the nitrocellulose solution, but it is preferable that the membrane be impregnated with the nitrocellulose solution.

An immersion period for immersing the polyolefin porous membrane in the nitrocellulose solution may be a period that enables a coating made of the nitrocellulose solution to be formed on the surface of the polyolefin porous membrane. In the after-mentioned examples, the polyolefin porous membrane is immersed in methanol in which nitrocellulose is dissolved, for about one minute so that the polyolefin porous membrane is coated with nitrocellulose, but the immersion period is not limited to this.

Further, in a transfer membrane integrated with an electrophoretic gel, in a case where the membrane adheres too tightly to the gel, when the transfer membrane is detached from the gel after a sample is transferred, it is difficult to detach the membrane from the gel. In such a case, there may occur a problem that a part of nitrocellulose on the surface of the membrane remains attached tightly to the gel. From this reason, it is preferable that the polyolefin porous membrane that is coated with nitrocellulose be hydrophilized. This allows the transfer membrane to be easily detached from the electrophoretic gel, and further avoids occurrence of unevenness of staining by lack of the nitrocellulose coating on the surface of the membrane.

The polyolefin porous membrane coated with nitrocellulose can be hydrophilized by a well-known hydrophilic method, which encompasses a method in which a polyolefin porous membrane coated with nitrocellulose is immersed into a hydrophilic buffer. However, the method is not limited to this. A period for immersing the polyolefin porous membrane into the buffer may be a period that allows the surface of the membrane coated with nitrocellulose to be hydrophilic. In the after-mentioned examples, the hydrophilic treatment is carried out in such a manner that a polyolefin porous membrane coated with nitrocellulose is immersed in a hydrophilic buffer containing Tris-HCL and CHAPS (3-[(3-Cholamidopropyl)dimethylammonio]propanesulfonate), and shaken for 10 minutes or more. However, the hydrophilic treatment is not limited to this.

In this way, with the use of the multilayer body of the present invention for electrophoresis and transfer, in which a polyolefin porous membrane and an electrophoresis support are integrated with each other, it is possible to consecutively carry out the processes of electrophoresing and transferring a sample. Further, it is possible to precisely transfer a separation pattern of the sample and to detach the membrane to which the sample has been transferred, from the electrophoresis support. Consequently, this makes it possible to skip complicated processes in electrophoresing and transferring a sample and analyzing the sample thus transferred, thereby realizing reduction in process time and effort.

(Coated Membrane Coated with a Water-Soluble Resin)

A coated membrane that is coated with a water-soluble resin (coating), for use as a transfer medium, is an appropriate membrane that is coated with a water-soluble resin, and a thin membrane that is capable of absorbing and fixing a separation pattern from an electrophoresis support while maintaining the pattern. The coated membrane that is coated with a water-soluble resin encompasses a membrane whose surface is covered with a coating made of a water-soluble resin, and a membrane that is impregnated with a water-soluble resin such that a solution containing the water-soluble resin sinks into a surface and an inside of the membrane. In other words, at least a surface of the membrane that comes into contact with an electrophoresis support may be coated with the water-soluble resin, but it is preferable that the membrane be impregnated with the solution containing the water-soluble resin.

The coating of the membrane may be realized in such a manner that an appropriate membrane is immersed into a solution containing a water-soluble resin so that a coating made of the water-soluble resin is formed on a surface of the membrane, or a membrane is immersed into the solution containing the water-soluble resin and shaken for a predetermined time so that the membrane is impregnated with the solution. However, the coating method is not limited to these.

When the membrane coated with the water-soluble resin is prepared so as to be integrated with an electrophoresis support, it is possible that the membrane adheres tightly to the electrophoresis support, which allows (i) a separation pattern of a sample separated by electrophoresis to be sufficiently transferred to the membrane, and (ii) the membrane to which the sample has been transferred to be detached from the electrophoresis support. As has been already described, the water-soluble resin for coating a membrane can realize an arrangement in which the electrophoresis support adheres tightly to the membrane to the extent that (i) the sample can be sufficiently transferred from the electrophoresis support to the membrane and (ii) the membrane can be detached from the electrophoresis support.

From this reason, it is necessary that the water-soluble resin for coating a membrane be a resin that is not easily melted when an electrophoresis support is formed. If the water-soluble resin coating a membrane is melted when an electrophoresis support is formed, it is considered difficult to provide a function to detach the membrane from the electrophoresis support. On this account, a water-soluble resin may be preferably: a water-soluble polymer, a polysaccharide, or a protein, the water-soluble polymer being synthesized from polyvinyl alcohol (PVA), polyacrylic acid, polymethacrylic acid, polyvinyl amine, or polyallylamine, the polysaccharide being starch, cellulose derivative, pectin, alginic acid, agarose, pullulan, or the like, and the protein being gelatin or the like, but is not limited to these. Among these resins, PVA is capable of forming a coating film with small oxygen permeability, and is effective for forming an electrophoresis support, especially a polyacrylamide gel that is formed by use of a radical polymerization, which is disturbed by oxygen.

Further, it is preferable that PVA for coating a membrane be fully saponified PVA. The fully saponified PVA means PVA that is almost fully saponified, and PVA whose saponification degree is higher than that of partially saponified PVA that includes, at a certain rate, a part that is not saponified. Saponification is a reaction in which ester is hydrolyzed by alkaline, and saponification degree indicates how much resin is saponified. When a membrane coated with fully saponified water-soluble PVA is prepared so as to be integrated with an electrophoresis support, it is possible that the membrane adheres tightly to the electrophoresis support more surely, thereby resulting in that a separation pattern of a sample on the electrophoresis support can be precisely transferred to the membrane. Further, it is possible to detach the transfer membrane from the electrophoresis support after the sample has been transferred to the membrane.

Moreover, it is preferable that polymerization degree of PVA for coating a membrane be 2000 to 4000. This allows a coated membrane to adhere tightly to an electrophoresis support more surely, thereby resulting in that a target material to be separated on the electrophoresis support can be sufficiently transferred to the coated membrane. When the polymerization degree is less than 2000, the membrane does not sufficiently adhere to the electrophoresis support, so that the separation pattern of the sample on the electrophoresis support cannot be sufficiently transferred to the membrane. Accordingly, this is not preferable.

Here, a membrane that is a conventional membrane generally used as a transfer membrane can be used as a membrane that is coated with a water-soluble resin, and the coated membrane is preferably a membrane that is selected from the group consisting of a polyvinylidene fluoride (PVDF) membrane, a nitrocellulose membrane, a polyolefin membrane, a polycarbonate membrane, a polyethersulfone membrane, a cellulose mixed ester membrane, a cellulose acetate membrane, and a polytetrafluoroethylene membrane. Further, it is preferable that the membrane that is coated with a water-soluble resin be coated with the water-soluble resin after the membrane is hydrophilized. The hydrophilic treatment that is carried out with respect to the membrane before the membrane is coated with the water-soluble resin can be carried out by a well-known hydrophilic method, and encompasses, for example, a method in which a membrane is immersed into a hydrophilic buffer, but is not limited to this. A period for immersing the membrane into the buffer may be a period that allows the surface of the membrane to be hydrophilic. In the after-mentioned examples, the hydrophilic treatment is carried out in such a manner that a PVDF membrane is immersed into a hydrophilic buffer containing Tris-HCL and SDS (sodium dodecyl sulfate), and shaken for 15 minutes or more. However, the hydrophilic treatment is not limited to this.

In this way, when the multilayer body of the present invention for electrophoresis and transfer is used, it is possible to consecutively carry out the processes of electrophoresing and transferring a sample. Further, it is possible to accurately transfer a separation pattern of the sample and to detach the membrane to which the separation pattern has been transferred from the electrophoresis support. Consequently, this makes it possible to skip complicated processes in electrophoresing and transferring a sample, and analyzing the sample thus transferred, thereby realizing reduction in process time and effort.

(Chip for Electrophoresis and Transfer)

A chip of the present invention for electrophoresis and transfer includes any of the multilayer bodies for electrophoresis and transfer described above. More specifically, the chip of the present invention includes a transfer medium and an electrophoresis support integrated with the transfer medium, and is formed such that the multilayer body for electrophoresis and transfer is made into a chip. The chip of the present invention for electrophoresis and transfer is formed, for example, in such a manner that a multilayer body for electrophoresis and transfer is sealed in a chip container that is constituted by a substrate and a cap, so that the multilayer body for electrophoresis and transfer is provided as one component. The chip of the present invention can be, in this state, attached to or removed from an electrophoresis apparatus, a transfer apparatus and the like, which allows a sample to be electrophoresed and transferred.

The chip of the present invention for electrophoresis and transfer may include at least the multilayer body of the present invention for electrophoresis and transfer in a chip container, and may further include constituents necessary for electrophoresis and transfer (a filter paper, and the like). Further, the chip of the present invention may include a sample that is to be electrophoresed and transferred by use of the chip of the present invention for electrophoresis and transfer.

The chip of the present invention for electrophoresis and transfer may be referred to as simply a chip, a cassette, or a cartridge. The multilayer body of the present invention for electrophoresis and transfer may not be fully sealed in the chip container, but be formed such that the multilayer body for electrophoresis and transfer is provided so as to be sandwiched between substrates so that the multilayer body for electrophoresis and transfer can be attached to or removed from an apparatus as one component.

The chip of the present invention for electrophoresis and transfer includes a multilayer body for electrophoresis and transfer in which a transfer medium is integrated with an electrophoresis support. This makes it possible to consecutively separate a sample by electrophoresis and transfer the sample, and to transfer precisely a separation pattern of the sample from the electrophoresis support to the transfer medium. Moreover, in the state where the multilayer body for electrophoresis and transfer is made into a chip, the chip can be attached to or removed from an electrophoresis apparatus and a transfer apparatus, so that a sample can be electrophoresed and transferred. This makes it possible to carry out more easily the processes of electrophoresing and transferring the sample. Furthermore, the multilayer body for electrophoresis and transfer is held in the chip container, which allows the multilayer body for electrophoresis and transfer to be kept in a state suitable for electrophoresis and transfer, and to be easily stored and distributed.

(Electrophoresis and Transfer Apparatus)

An electrophoresis and transfer apparatus of the present invention is an apparatus for electrophoresing and transferring a target material to be separated, by use of the multilayer body for electrophoresis and transfer or the chip for electrophoresis and transfer. The electrophoresis and transfer apparatus of the present invention: includes separation means for separating a target material to be separated on the electrophoresis support; and transfer means for transferring the target material thus separated on the electrophoresis support to the transfer medium.

Since the electrophoresis and transfer apparatus of the present invention electrophoreses and transfers a sample by use of the multilayer body of the present invention for electrophoresis and transfer or the chip of the present invention for electrophoresis and transfer, it is not necessary to attach a transfer membrane to an electrophoretic gel after the sample is separated by electrophoresis according to the separation means, thereby resulting in that electrophoresis and transfer can be carried out consecutively. Consequently, this makes it possible to skip complicated processes in electrophoresing and transferring a sample, and analyzing the sample thus transferred, thereby realizing reduction in process time.

(Electrophoresis and Transfer Method)

An electrophoresis and transfer method of the present invention is a method for electrophoresing and transferring a target material to be separated, by use of either of the multilayer body for electrophoresis and transfer or the chip for electrophoresis and transfer. The electrophoresis and transfer method of the present invention includes the steps of: (a) separating the target material on the electrophoresis support; and (b) subsequently to the step (a), transferring the target material thus separated on the electrophoresis support to the transfer medium. Moreover, the electrophoresis and transfer method of the present invention may further include the step of: (c) subsequently to the step (b), detaching the transfer medium to which the target material has been transferred, from the electrophoresis support.

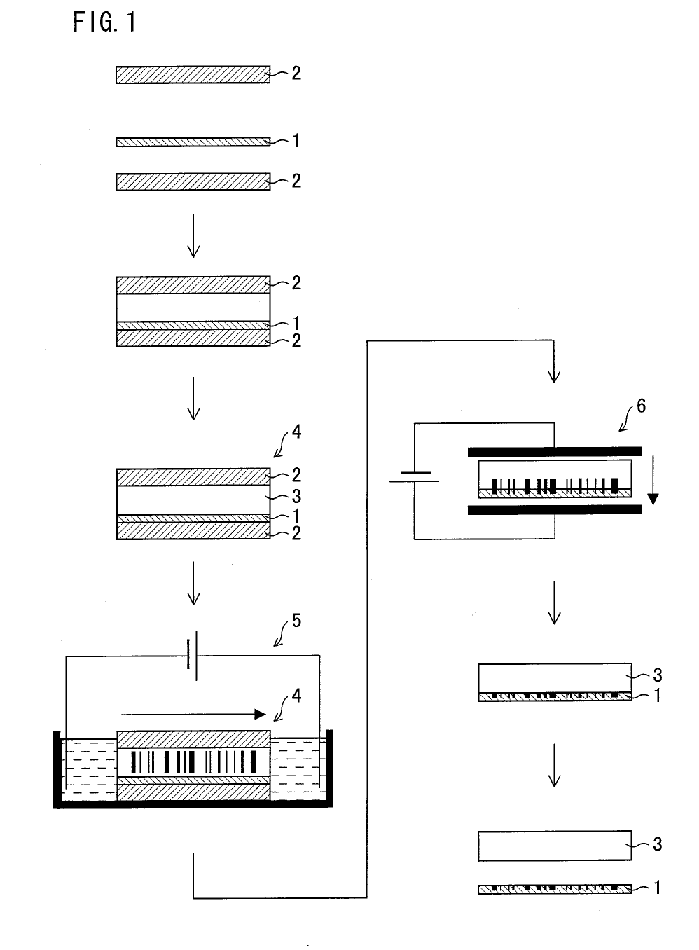

The electrophoresis and transfer method of present invention and its precedent step are described below with reference to FIG. 1. FIG. 1 is a view schematically illustrating the step of forming the chip of present invention for electrophoresis and transfer and the steps in the electrophoresis and transfer method of the present invention. As illustrated in FIG. 1, the chip of the present invention for electrophoresis and transfer is formed in the step precedent to the steps of electrophoresing and transferring the sample by the electrophoresis and transfer method of the present invention. Firstly, a transfer membrane (transfer medium) 1 and a chip container 2 are prepared. The transfer membrane 1 is placed on a chip substrate 2, a chip cap is provided thereon, and the chip substrate 2 and the chip cap are bonded together by welding. A gel solution is filled onto the transfer membrane 1 in the chip container 2, and the chip cap 2 covers the chip container 2 so that the gel solution is polymerized, thereby forming an electrophoretic gel 3. In this way, a chip 4 for electrophoresis and transfer is formed.

Next, a sample is electrophoresed and transferred by use of the chip 4 for electrophoresis and transfer. The chip 4 for electrophoresis and transfer that is formed in the precedent step is placed in an electrophoresis apparatus 5, and a voltage is applied thereto, so that the sample in the electrophoretic gel 3 is separated in a direction of an arrow. After the electrophoresis is completed, the chip 4 for electrophoresis and transfer is taken out from the electrophoresis apparatus 5, and a multilayer body (a multilayer body for electrophoresis and transfer) constituted by the electrophoretic gel 3 and the transfer membrane 1 is taken out from the chip 4. The multilayer body thus taken out from the chip 4 is then placed in a transfer apparatus 6, and a voltage is applied thereto. By applying the voltage, the sample separated on the electrophoretic gel 3 is transferred to the transfer membrane 1 while maintaining its separation pattern. Further, the multilayer body is taken out from the transfer apparatus 6, and the transfer membrane 1 is detached from the electrophoretic gel 3. The transfer membrane 1 thus detached may be stained so that the sample on the transfer membrane 1 may be analyzed.

In the electrophoresis and transfer method of the present invention, the step (a) (the separating step) can be carried out by a well-known electrophoresis method, and the method is not especially limited and may be appropriately selected according to types of a sample to be separated, a purpose of analysis, and the like. A preferable electrophoresis method is, for example, agarose gel electrophoresis, polyacrylamide gel electrophoresis (PAGE), SDS-PAGE, isoelectric focusing, two-dimensional electrophoresis, and the like. Further, submarine electrophoresis in which an electrophoretic gel is horizontally placed in a buffer, or slab electrophoresis in which a gel sandwiched between glass plates and vertically placed is also applicable.

Moreover, the step (b) (the transferring step) can be carried out by a conventional transfer method, and the method is not limited especially. The method may be appropriately selected according to types of a sample to be transferred, a purpose of analysis, and the like. A preferable transfer method is, for example, electroblotting, vacuum blotting, a capillary method, and the like. Further, tank or semi-dry blotting is also applicable.

In the step (c) (the detaching step) in the electrophoresis and transfer method of the present invention, after the transfer membrane is detached from the electrophoretic gel, a process such as staining may be carried out for analyzing the sample on the transfer membrane thus detached. Such a process that is carried out with respect to the sample on the transfer membrane may be chemical staining, hybridization, immune reaction, autoradiography, and the like.

With the use of the electrophoresis and transfer method of the present invention, a sample is electrophoresed and transferred by use of the multilayer body of the present invention for electrophoresis and transfer or the chip of the present invention for electrophoresis and transfer. Accordingly, it is not necessary that the transfer membrane be attached to the electrophoretic gel after the sample is electrophoresed in the step (a) (the separating step), thereby resulting in that the steps (a) and (b) (the separating and transferring steps) can be carried out consecutively. Moreover, with the use of the multilayer body of the present invention for electrophoresis and transfer or the chip of the present invention for electrophoresis and transfer in which a specified transfer membrane and a specified electrophoretic gel are integrated with each other, the transfer membrane to which the sample has been transferred can be easily detached from the electrophoretic gel. Consequently, this makes it possible to skip complicated processes in electrophoresing and transferring a sample, and analyzing the sample thus transferred, thereby realizing reduction in process time and effort.

(Method for Manufacturing Multilayer Body for Electrophoresis and Transfer)

A method of the present invention for manufacturing the multilayer body for electrophoresis and transfer includes the step of forming an electrophoresis support by filling a material of the electrophoresis support onto a transfer medium. It is possible to manufacture the chip of the present invention for electrophoresis and transfer by use of the multilayer body for electrophoresis and transfer that is manufactured by the manufacturing method. A well-known transfer medium can be used as a transfer medium in the step of forming the electrophoresis support, but the transfer medium is preferably the aforementioned polyolefin porous membrane or water-soluble resin coated membrane. As a material of the electrophoresis support that is filled onto the transfer medium, a well-known material that forms a well-known electrophoresis support can be used. The material is, for example, filled onto the transfer membrane and polymerized, so that the electrophoresis support can be formed so as to be integrated with the transfer membrane.

It is preferable that the manufacturing method of the present invention further include, precedent to the step of forming the electrophoresis support, the step of preparing the transfer medium by immersing a polyolefin porous membrane containing a polyolefin resin as its main component into a solution containing 0.5 to 3 mg/ml of nitrocellulose. In a case where a concentration of nitrocellulose in the nitrocellulose solution for coating the polyolefin porous membrane is less than 0.5 mg/ml, when the membrane to which a sample has been transferred is stained, the sample is not sufficiently stained. Meanwhile, in a case where the concentration is more than 3 mg/ml, a background is too high. From these reasons, it is not preferable that the concentration be less than 0.5 mg/ml or more than 3 mg/ml.

Furthermore, the manufacturing method of the present invention may include, precedent to the step of forming the electrophoresis support, the step of preparing the transfer membrane by immersing a membrane into a solution containing 5 to 7.5% by weight of a water-soluble resin. In a case where a water-soluble resin concentration of the water-soluble resin solution for coating the membrane is less than 5%, when a water-soluble resin coated membrane is formed, the membrane to which a sample has been transferred cannot be detached from the electrophoresis support. Meanwhile, in a case where the concentration is more than 7.5%, a separation pattern to be transferred to the membrane is disordered. Accordingly, it is not preferable that the concentration be less than 5% or more than 7.5%.

In the multilayer body of the present invention for electrophoresis and transfer, it is preferable that the transfer medium be a polyolefin porous membrane containing a polyolefin resin as its component, or a coated film that is coated with a water-soluble resin. This improves precision in transferring a separation pattern of a target material to be separated, and allows the transfer membrane to be easily detached from the electrophoresis support. Further, this does not prevent the separating of the target material by electrophoresis and the transferring of the target material. Consequently, each step of electrophoresis, transfer, and preparation of analysis of the target material that has been transferred can be efficiently and easily carried out.

Moreover, in the multilayer body of the present invention for electrophoresis and transfer, it is preferable that the polyolefin resin that is a main component of the polyolefin porous membrane be a resin selected from the group consisting of polyethylene, polypropylene, poly(a-olefin), modified polyethylene, and modified polypropylene. This allows the electrophoresis support to adhere tightly to the polyolefin porous membrane to an extent that (i) a target material to be separated can be sufficiently transferred from the electrophoresis support to the membrane, and (ii) the polyolefin porous membrane can be detached from the electrophoresis support.

Furthermore, in the multilayer body of the present invention for electrophoresis and transfer, the polyolefin porous membrane is preferably coated with nitrocellulose, further preferably impregnated with nitrocellulose. This makes it possible to stain a target material that has been transferred on the polyolefin porous membrane, so that the target material is observable and detectable. The nitrocellulose does not prevent polymerization of a solution of the electrophoresis support on the membrane.

Further, in the multilayer body of the present invention for electrophoresis and transfer, it is preferable that the membrane coated with nitrocellulose be hydrophilized. This makes it possible to easily detach the polyolefin porous membrane from the electrophoresis support, and to avoid disarrangement of a separation pattern of a target material or occurrence in unevenness of staining caused by lack of nitrocellulose coating on a surface of the membrane.

In the multilayer body of the present invention for electrophoresis and transfer, it is preferable that the polyolefin porous membrane be 0.2 to 0.5 μm in pore diameter. This makes it possible to sufficiently transfer a separation pattern of a target material from the electrophoresis support to the polyolefin porous membrane, and to fix the separation pattern that has been transferred to the polyolefin porous membrane.

Further, in the multilayer body of the present invention for electrophoresis and transfer, it is preferable that the coated membrane that is coated with a water-soluble resin be impregnated with the water-soluble resin. Moreover, in the multilayer body of the present invention for electrophoresis and transfer, the water-soluble resin is preferably a water-soluble polymer, a polysaccharide, or a protein, the water-soluble polymer being synthesized from polyvinyl alcohol (PVA), polyacrylic acid, polymethacrylic acid, polyvinyl amine, polyallylamine, or the like, the polysaccharide being starch, cellulose derivative, pectin, alginic acid, agarose, pullulan, or the like, and the protein being gelatin or the like. This allows the electrophoresis support to adhere tightly to the coated membrane to an extent that (i) a target material can be sufficiently transferred from the electrophoresis support and (ii) the coated membrane can be detached from the electrophoresis support.

Further, in the multilayer body of the present invention for electrophoresis and transfer, it is preferable that the coated membrane be coated with the water-soluble resin, the membrane being selected from the group consisting of a polyvinylidene fluoride (PVDF) membrane, a nitrocellulose membrane, a polyolefin membrane, a polycarbonate membrane, a polyethersulfone membrane, a cellulose mixed ester membrane, a cellulose acetate membrane, and a polytetrafluoroethylene membrane. Furthermore, it is preferable that the coated membrane be prepared such that a hydrophilized membrane is coated with the water-soluble resin.

The present invention is not limited to the description of the embodiments above, but may be altered by a skilled person within the scope of the claims. An embodiment based on a proper combination of technical means disclosed in different embodiments is encompassed in the technical scope of the present invention.

The following explanation deals with the present invention in more detail with reference to examples, but the present invention is not limited to these examples.

### EXAMPLE

[1. Materials and Methods]

(1-1. Preparation of Polyolefin Porous Membrane)

Porous membranes made of polyolefin whose size was 5×6 cm (Hipore membrane, made by Asahikasei Chemicals Corporation) were used as transfer membranes. The polyolefin porous membranes used in the example were made of 100% polyethylene. Note that, the porous polyolefin membranes used here were (i) a membrane that was less than 0.2 μm in pore diameter (average pore diameter 0.05 to 0.06 μm: NA635 (small pore diameter), made by Asahikasei Chemicals Corporation), and (ii) a membrane that was 0.2 to 0.5 μm in pore diameter (average pore diameter 0.5 μm: H6022 (large pore diameter), made by Asahikasei Chemicals Corporation). Further, the membranes were 27 μm and 55 μm in thickness, respectively.

The polyolefin porous membranes were immersed into 100% methanol, in which nitrocellulose was dissolved, for one minute, so that the membranes were coated with nitrocellulose. Immediately after extra solution on the membranes was removed, the membranes were immersed into a hydrophilic buffer so that the membranes were not dried, and then shaken for at least 10 minutes.

Considering effects and the like with respect to electrophoresis, a buffer containing 375 mM Tris-HCL (pH 8.8), which was close to a composition of the electrophoretic gel, and 0.2% CHAPS (3-[(3-Cholamidopropyl)dimethylammonio]propanesulfonate) was used as the hydrophilic buffer. Instead of CHAPS that is a surfactant, SDS with the same concentration may be used.

(1-2. Preparation of PVA Coated Membrane)

Polyvinylidene fluoride membranes (PVDF membrane; ImmobilonFL, made by Milipore, pore diameter 0.45 μm) that were coated with polyvinyl alcohol (PVA) were used as transfer membranes. Four types of PVA, Resins 1 through 4 described below, were used: Resin 1 (made by Wako Junyaku, fully saponified type, average degree of polymerization 500); Resin 2 (made by Wako Junyaku, fully saponified type, average degree of polymerization 2000); Resin 3 (made by SIGMA-ALDRICH, fully saponified type, average degree of polymerization 4000); and Resin 4 (made by Wako Junyaku, partially saponified type, average degree of polymerization 2000). Each PVA was heated and dissolved in water so as to obtain a solution.

Immediately after the PVDF membranes were immersed into 100% methanol for around one minute, the membranes were immersed into a hydrophilic buffer so that the membranes were not dried, and then shaken for at least 10 minutes. Considering effects and the like with respect to electrophoresis, a buffer containing 375 mM Tris-HCL (pH 8.8) that was close to a composition of the electrophoretic gel and 0.2% SDS was used as the hydrophilic buffer.

The PVDF membranes were then taken out from the hydrophilic buffer, respectively immersed into each of the PVA solutions, and shaken for at least 15 minutes. After that, each of the PVDF membranes was taken out from each PVA solution, and extra solution was removed. The PVDF membranes were then dried at 80° C. for about 30 minutes.

(1-3. Preparation of Electrophoretic Gel and Chip for Electrophoresis and Transfer)

The polyolefin porous membranes prepared in 1-1 or the PVA coated membranes prepared in 1-2 were respectively placed on surfaces of substrates of plastic containers in which a gel-forming region was 5×6 cm, and extra buffer was removed by use of a paper filter to an extent that the membranes were not dried. Then, the containers were covered with caps, and the containers and the caps were respectively bonded by welding with the use of an ultrasonic bonding device. After a bottom section of the gel-forming region was sealed, a polyacrylamide gel solution was filled into the gel-forming region from a top section thereof, and the containers were left to stand so that the gel was polymerized.

The polyacrylamide gel solution used in the example contained 13% acrylamide, 375 mM Tris-HCL (pH8.8), 0.1% ammonium persulfate, and 0.1% tetramethylethylene diamine. A mixed solution of 29.2% acrylamide and 0.8% methylenebisacrylamide was added to the polyacrylamide gel solution so that a final concentration of acrylamide in the polyacrylamide gel was 13%.

(1-4. Sample)

As a sample to be electrophoresed and transferred, a stained molecular-weight marker and an unstained protein molecular-weight marker were used. As the stained molecular-weight marker, SeeBlue Pre-Stained Standard (made by Invitrogen) and SeeBlue Plus2 Pre-Stained Standard (made by Invitrogen) were used. As the unstained protein molecular-weight marker, Mark12 Unstained Standard (made by Invitrogen) was used, and the marker was chemically stained or immunostained after the marker was transferred.

(1-5. Electrophoresis)

A sample and 1% agarose were mixed and loaded on a well of a chip for electrophoresis and transfer that was prepared in 1-3, and were subjected to SDS-PAGE. A cathode buffer containing 25 mM Tris, 192 mM glycine, and 0.1% SDS, and an anode buffer containing 150 mM Tris-HCL (pH 8.8) were used as an electrophoresis buffer. The chip for electrophoresis and transfer on which the sample was placed was solidified at 4° C. for about 5 minutes, and placed in an electrophoresis apparatus. Five milliliter of each buffer was added to a buffer bath of the apparatus, and electrophoresis was carried out at a constant current of 20 mA for 30 minutes.

(1-6. Transfer)

After the electrophoresis was completed, the chip was taken out from the electrophoresis apparatus, and further the membrane and the electrophoretic gel, which were integrated with each other, were taken out from the chip. The membrane and the electrophoretic gel thus taken out were placed in iBlot transfer stacks, Mini (made by Invitrogen), and then placed in iBlot gel transfer system (made by Invitrogen). In accordance with a protocol, a constant voltage of 23V was applied to the membrane and the electrophoretic gel for 6 minutes, so that the sample developed in the gel was transferred to the membrane.

(1-7. Staining and Detection of Sample)

After the sample was transferred, the membrane was detached from the electrophoretic gel and washed out with distilled water. In regard to the unstained protein molecular-weight marker sample, the sample was chemically stained and immunostained.

In accordance with a protocol, the chemical staining of the sample was carried out in the similar manner to a well-known technique of staining a transfer membrane. The membrane was immersed into a solution containing 10% methanol and 7% acetic acid for 15 minutes so as to fix the sample on the membrane, and washed out with distilled water four times each for about 5 minutes. Then, the membrane was stained for about 15 minutes by SYPRO Ruby protein blot stain solution (made by Invitrogen). After the membrane was further washed out with distilled water four to six times each for 1 minute, fluorescence of SYPRO Ruby was detected by use of ProXpress Proteomic Imaging System (made by Perkin-Elmer), so that the stained sample was detected.

Immunostaining of the sample was carried out in the following manner. After the membrane was blocked for at least 1 hour by use of a Tris-HCL buffered saline solution (blocking solution) containing 0.1% Tween-20 in which 5% bovine serum albumin was dissolved, the membrane was immersed into a blocking solution to which carbonic anhydrase antibody was added, and reacted for at least 1 hour. The membrane was then washed out three times each for 10 minutes with a Tris-HCL buffered saline solution containing 0.1% Tween-20 (TBST), immersed into an antibody diluent solution with respect to immunoglobulin G labeled by Quantum dot 655, and reacted for at least 1 hour. After the membrane was washed out with TBST three times each for 10 minutes, fluorescence of Quantum dot 655 was detected by use of Typhoon Trio (made by GE Healthcare), so that a peculiar antigen-antibody reaction of the sample was detected.

[2. Results]

With the use of the chip of the present invention for electrophoresis and transfer, studies were conducted on suitable conditions of a membrane that is integrated with a gel, under which condition electrophoresis and transfer can be finely carried out.

(2-1. Pore Diameter and Membrane Thickness of Polyolefin Porous Membrane)

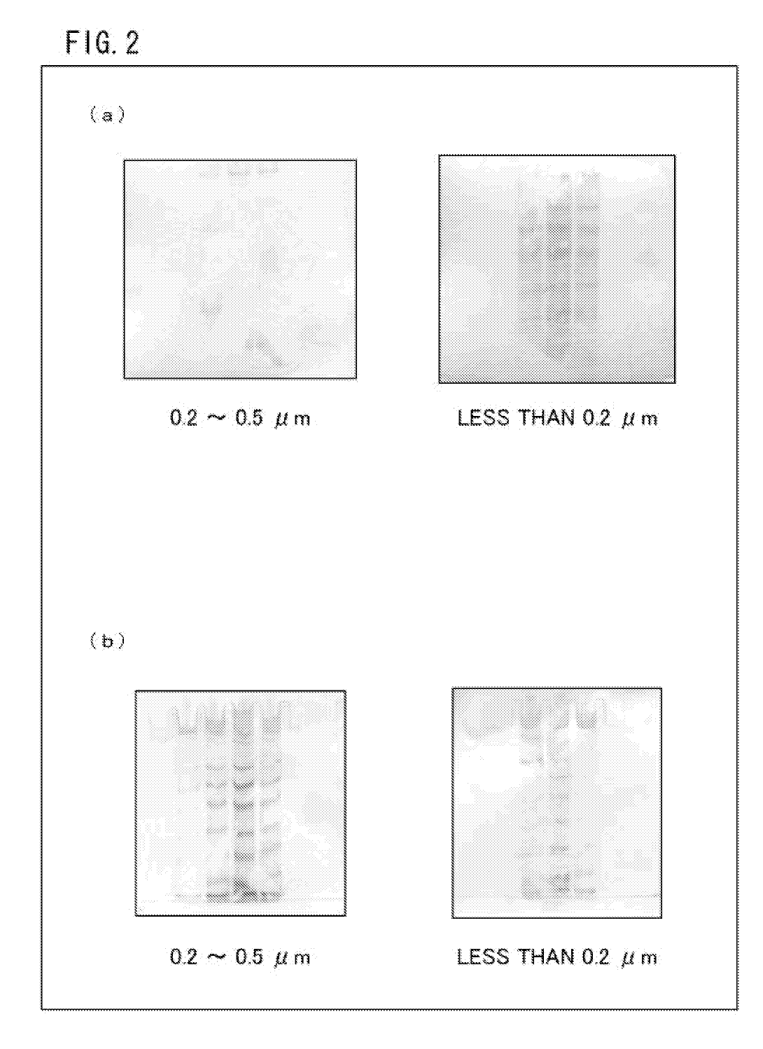

With the use of polyolefin porous membranes whose pore diameter and membrane thickness were different from each other, studies were conducted on a suitable pore diameter and membrane thickness. Chips for electrophoresis and transfer were formed by use of (a) a polyolefin porous membrane with 0.2 to 0.5 μm in pore diameter and (b) a polyolefin porous membrane with less than 0.2 μm in pore diameter, respectively. Stained markers were electrophoresed and transferred to the membranes. FIG. 2 shows results. FIG. 2 shows the electrophoretic gels (FIG. 2(a)) and the polyolefin porous membranes (FIG. 2(b)), to which electrophoresis and transfer were carried out.

Either of the cases where the polyolefin porous membranes whose pore diameters were different to each other were used had no effect on the electrophoresis, and in either case, the marker was developed in the electrophoretic gel without any problems. However, in comparison between the membranes after the transfer was completed, as shown in FIG. 2(b), in the case of the polyolefin porous membrane with 0.2 to 0.5 μm in pore diameter, proteins were transferred to the membrane without any problems (left one in FIG. 2(b)), whereas, in the case of the polyolefin porous membrane with less than 0.2 μm in pore diameter, the transfer of the sample was disturbed, thereby resulting in that little proteins were transferred to the polyolefin porous membrane (right one in FIG. 2(b)).

The results shown in FIG. 2 are the ones when polyolefin porous membranes with 27 μm in thickness were used. The after-mentioned examination results by use of polyolefin porous membranes are the ones of examinations that were carried out by use of polyolefin porous membranes with 0.2 to 0.5 μm in pore diameter and 27 μm in thickness.

(2-2. Nitrocellulose Coating and Hydrophilic Treatment with Respect to Polyolefin Porous Membrane)

When a polyolefin porous membrane was hydrophilized in a similar manner to a well-known transfer membrane, the polyolefin porous membrane could not be immersed into a hydrophilic buffer because the polyolefin porous membrane was hydrophobic. On this account, before the hydrophilic treatment was carried out, a polyolefin porous membrane was immersed into a nitrocellulose solution that was obtained such that nitrocellulose was dissolved in 100% methanol so that the membrane was coated with nitrocellulose. As a result, the polyolefin porous membrane could be hydrophilized.

For the sake of studies on how the nitrocellulose coating and the hydrophilic treatment have an effect on detaching a membrane from a gel after transfer is completed, examinations were carried out as follows. A membrane that was simply hydrophilized, a membrane that was simply coated with nitrocellulose, and a membrane that was coated with nitrocellulose and then hydrophilized were prepared, and chips for electrophoresis and transfer were formed by use of the different membranes, respectively. Electrophoresis and transfer were carried out with respect to each of the chips. Results of the examinations were such that, in either of the cases where the above polyolefin porous membranes were used, the membranes could be detached from the electrophoretic gels after the transfer was completed. However, in the case of the membrane that was simply coated with nitrocellulose, the membrane adhered too tightly to the gel, and was not easily detached from the gel.

(2-3. Chemical Staining of Polyolefin Porous Membrane)

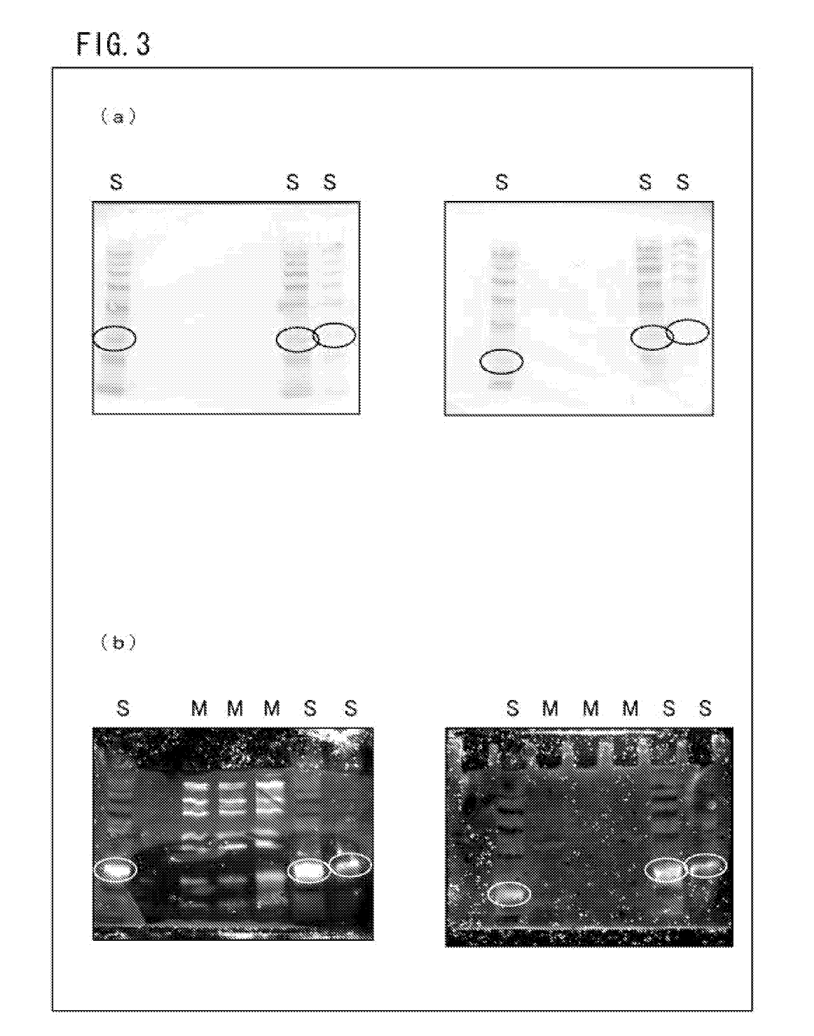

With the use of chips for electrophoresis and transfer, samples were electrophoresed and transferred to polyolefin porous membranes. Studies were conducted on whether or not the polyolefin porous membranes to which the samples had been transferred could be chemically stained in a similar manner to a publicly known transfer membrane. Stained makers (S: SeeBlue Plus2 Pre-Stained Standard) and unstained markers (M: Mark12 Unstained Standard) were electrophoresed and transferred to polyolefin porous membranes, respectively, and each of the polyolefin porous membrane was detached from a gel. The membranes including the unstained maker were stained by use of SYPRO Ruby protein blot stain. For the sake of studies on how the nitrocellulose coating of a membrane has an effect on staining, experiments were conducted with the use of (a) a membrane that was not coated with nitrocellulose and (b) a membrane that was coated with nitrocellulose and subsequently hydrophilized. FIG. 3 shows results.

FIG. 3 shows polyolefin porous membranes that were not exposed to fluorescent (FIG. 3(a)) and polyolefin porous membranes that were exposed to fluorescent (FIG. 3(b)). In FIG. 3(a), only the stained marker (S) can be observed. In FIG. 3(b), it is observed that proteins of the unstained marker (M) were stained. In FIGS. 3(a) and (b), (i) results of cases where the membranes that were coated with nitrocellulose were used, are shown on the left side of the figure, and (ii) results of cases where the membranes that were not coated with nitrocellulose were used, are shown on the right side of the figure.

As shown in FIG. 3(a), the stained markers (S) were transferred to the polyolefin porous membranes, and this could be observed regardless of whether or not the membranes were coated with nitrocellulose. On this account, the transfer itself was carried out regardless of whether or not the membranes were coated with nitrocellulose. As shown in FIG. 3(b), the membranes that were coated with nitrocellulose (on the left side in FIG. 3(b)) were stained, and the unstained makers (M) could be detected. However, the membranes that were not coated with nitrocellulose (on the right side in FIG. 3(b)) were not stained, and the unstained makers (M) could not be detected.

Note that, in FIG. 3, although bands of the stained markers (S) (parts that are circled) appear to be stained, the bands generate excitation light at the same fluorescent wavelength as SYPRO Ruby, thereby causing the bands to appear to be stained.

(2-4. Immunostaining of Polyolefin Porous Membrane)

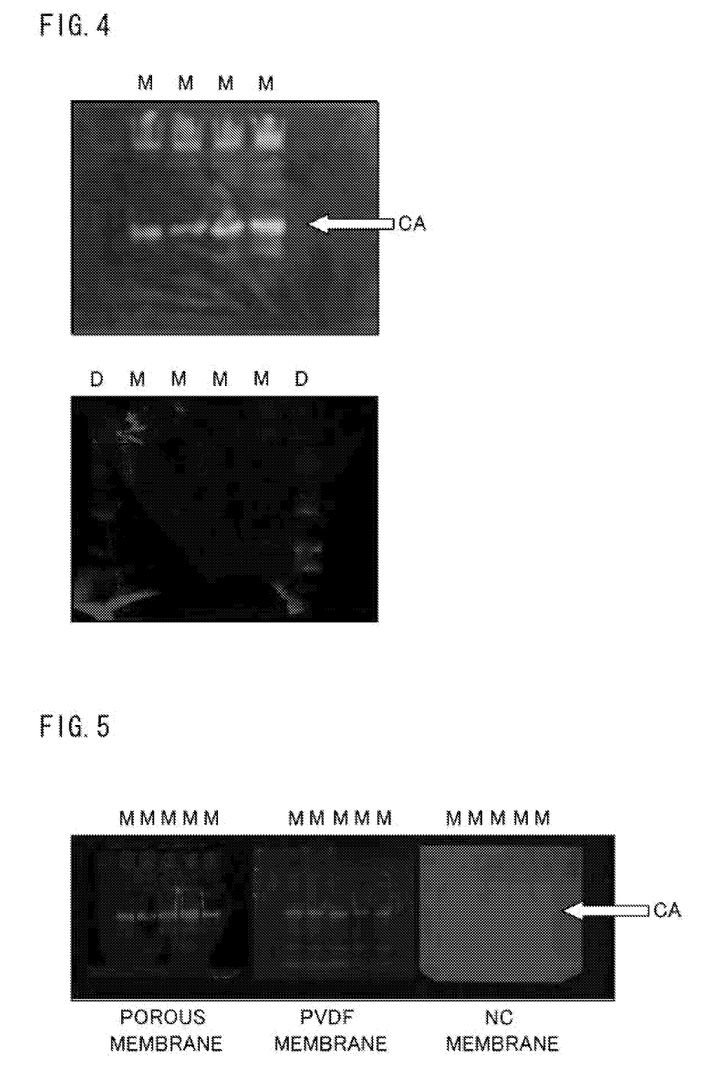

With the use of chips for electrophoresis and transfer, samples were electrophoresed and transferred to polyolefin porous membranes. Studies were conducted on whether or not the polyolefin porous membranes to which the samples had been transferred could be immunostained in a similar manner to a publicly known transfer membrane. Chips for electrophoresis and transfer were formed by use of (a) a polyolefin porous membrane that was coated with nitrocellulose and (b) a polyolefin porous membrane that was not coated with nitrocellulose, respectively. Unstained markers (M) were electrophoresed and transferred to the membranes. After the transfer, each of the polyolefin porous membranes was detached from a gel, and the polyolefin porous membranes were immunostained by use of carbonic anhydrase primary antibody (CA) and Quantum dot 655 secondary antibody. FIG. 4 shows results.

In FIG. 4, (i) results of cases where the membranes that were coated with nitrocellulose were used are shown on the upper side of the figure, and (ii) results of cases where the membranes that were not coated with nitrocellulose were used are shown on the downside of the figure. As shown in FIG. 4, in the polyolefin porous membranes that were coated with nitrocellulose, proteins, in the unstained marker (M), that were peculiarly combined with the carbonic anhydrase primary antibody (CA) were detected (on the upper side of the figure).

On the other hand, in the polyolefin porous membranes that were not coated with nitrocellulose, the proteins could not be detected by carbonic anhydrase primary antibody (CA) (on the downside of the figure). Note, however, that, in the polyolefin porous membranes that were not coated with nitrocellulose, fluorescently labeled molecular weight markers (D: DyLight Protein Molecular Weight Marker) were transferred to the membranes at the same time, and the makers (D) could be observed. On this account, the transfer itself was carried out without any troubles.

Further, studies were conducted on immunostaining properties of the polyolefin porous membrane coated with nitrocellulose and a publicly known transfer membrane. As the publicly known transfer membrane, a PVDF membrane and a nitrocellulose (NC) membrane were used. The PVDF membranes and the NC membranes were hydrophilized in a conventional manner, and each of the membranes was attached to a gel to which electrophoresis was carried out, so that unstained markers (M) were transferred thereto. The membranes were then immunostained in the similar manner to the above. FIG. 5 shows results.

As shown in FIG. 5, it was demonstrated that the polyolefin porous membranes (on the left side of the figure) had the same staining property as that of the PVDF membranes (in the center of the figure). On the other hand, in the NC membranes (on the right side of the figure), it was demonstrated that the background was increased in fluorescent detection.

(2-5. Concentration of Nitrocellulose)

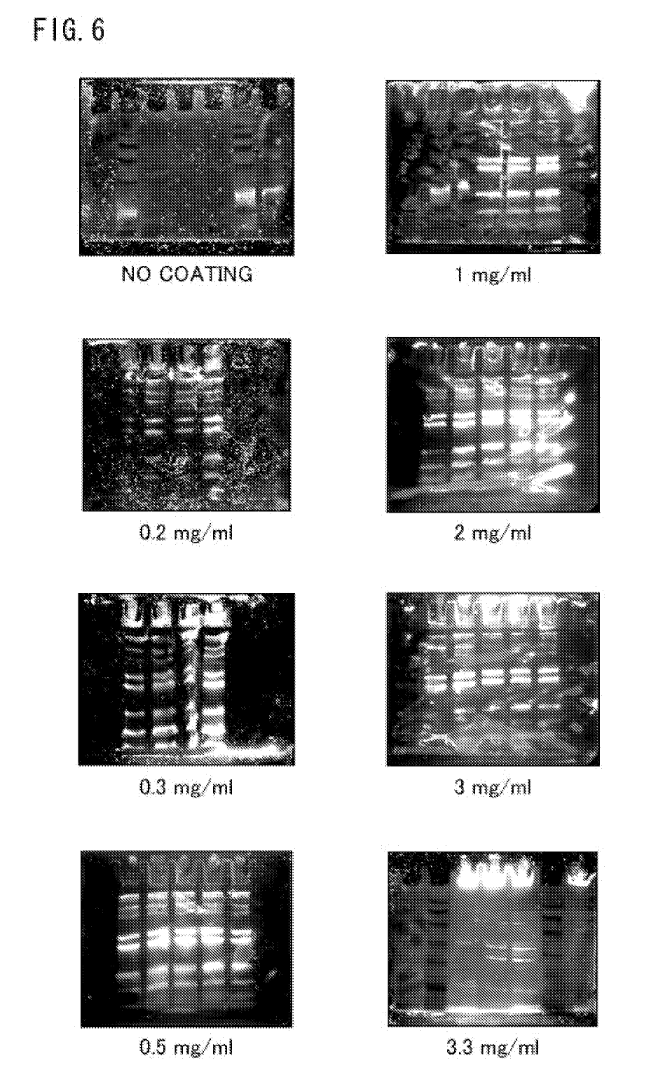

Studies were conducted on a concentration of nitrocellulose contained in a nitrocellulose solution for coating a polyolefin porous membrane. In chips for electrophoresis and transfer respectively formed by use of polyolefin porous membranes each coated with different solutions having different concentrations of nitrocellulose, unstained markers were electrophoresed and transferred to the membranes, and each of the membranes was detached from a gel and chemically stained. FIG. 6 shows results.

As illustrated in FIG. 6, in polyolefin porous membranes that were coated with use of a solution whose nitrocellulose concentration was higher than 3 mg/ml (for example, 3.3 mg/ml), staining of the markers was disturbed and the background was increased. Further, in polyolefin porous membranes that were coated with use of a solution whose nitrocellulose concentration was 3 mg/ml, the markers were stained but chromatic figures of proteins having higher molecular weight were dimmed. Meanwhile, in polyolefin porous membranes that were coated, respectively, by use of solutions whose nitrocellulose concentrations were 0.2 and 0.3 mg/ml, their backgrounds were decreased and each staining property of the markers was decreased. On the other hand, in polyolefin porous membrane that were coated, respectively, by use of solutions whose nitrocellulose concentrations were 0.5, 1 and 2 mg/ml, the makers were clearly stained.

(2-6. Hydrophilic Treatment with Respect to Polyolefin Porous Membrane Coated with Nitrocellulose)

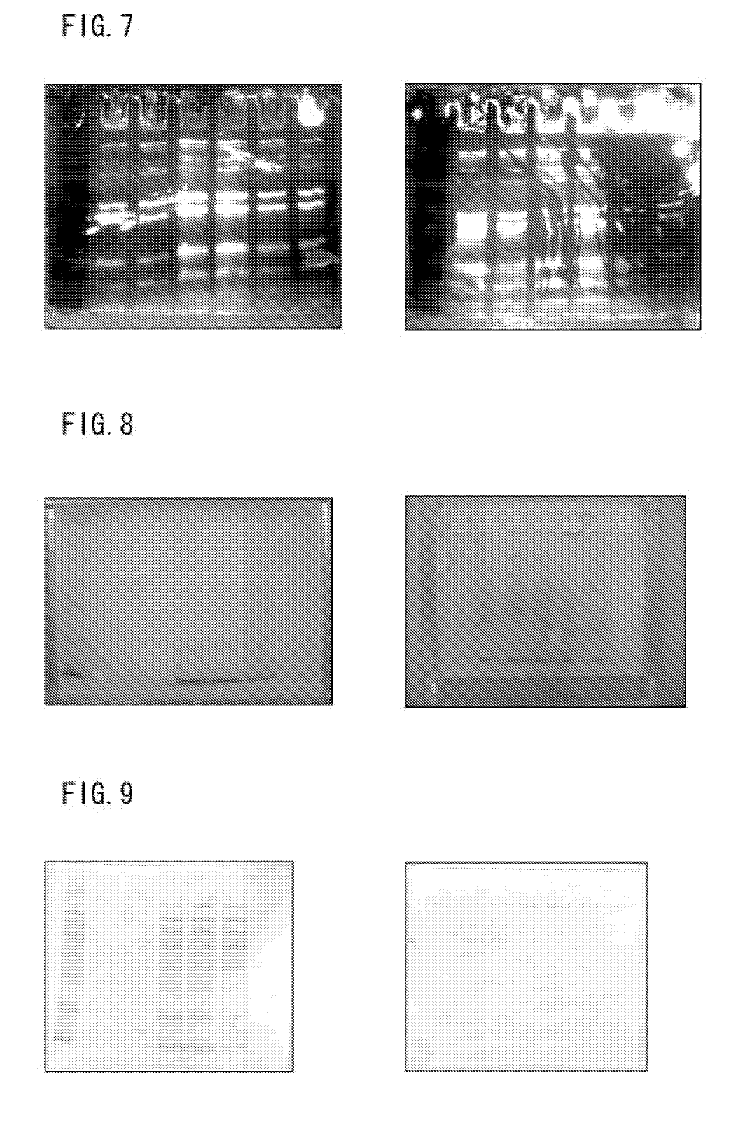

Studies were conducted on the necessity of the hydrophilic treatment after a polyolefin porous membrane was coated with nitrocellulose. Chips for electrophoresis and transfer were formed, respectively, by use of (a) a polyolefin porous membrane that was coated with nitrocellulose and subsequently hydrophilized, and (b) a polyolefin porous membrane that was simply coated with nitrocellulose. After unstained markers were electrophoresed and transferred to the membranes, the membranes were chemically stained. FIG. 7 shows results. In FIG. 7, (i) results of cases where the membranes that were coated with nitrocellulose and subsequently hydrophilized were used are shown on the left side of the figure, and (ii) results of cases where the membranes that were simply coated with nitrocellulose were used are shown on the right side of the figure.

As illustrated in FIG. 7, although the markers thus transferred were stained regardless of whether the membranes were hydrophilized or not, chromatic figures of the membranes that were simply coated with nitrocellulose (on the right of the figure) tended to be uneven. Since such the membrane that is simply coated with nitrocellulose is not easily detached from gels after transfer is completed, nitrocellulose on a surface of the membrane partially remains in the gel when the membrane is detached from the gel. Consequently, this can cause unevenness in staining.

(2-7. Saponification Degree of PVA)

Studies were conducted on a saponification degree of PVA for coating a PVDF membrane. Chips for electrophoresis and transfer were formed, respectively, by used of PVDF membranes that were impregnated with solutions containing PVA having different saponification degrees. Then, stained markers were electrophoresed and transferred to the membranes. PVA solutions used in experiments were: (a) a PVA solution containing 5% by weight of PVA of Resin 2 (fully saponified type); and (b) a PVA solution containing 5% by weight of PVA of Resin 4 (partially saponified type). Results are shown in FIG. 8 and FIG. 9. FIG. 8 shows electrophoretic gels that were electrophoresed, and FIG. 9 shows PVA coated membranes to which samples were transferred from the gels that had been electrophoresed. In FIGS. 8 and 9, (i) results of cases where Resin 2 (fully saponified type) was used are shown on the left side of the figures, and (ii) results of cases where Resin 4 (partially saponified type) was used are shown on the right side of the figures.

As illustrated in FIG. 8, either of the cases where the fully saponified PVA and the partially saponified PVA were used had no effect on electrophoresis. Further, the markers were developed in the electrophoretic gels without any problems. Meanwhile, in comparison of the membranes to which the samples were transferred, as illustrated in FIG. 9, (i) in the cases where the membranes that were coated with the fully saponified PVA were used, proteins were transferred without any problems (on the left side of the figure), whereas (ii) in the cases where the membranes that were coated with the partially saponified PVA, separation patterns of the transferred markers were uneven (on the right side of the figure). Note that, in either case where the fully or partially saponified PVA was used, the membranes could be detached from the electrophoretic gels.

(2-8. Polymerization Degree of PVA)

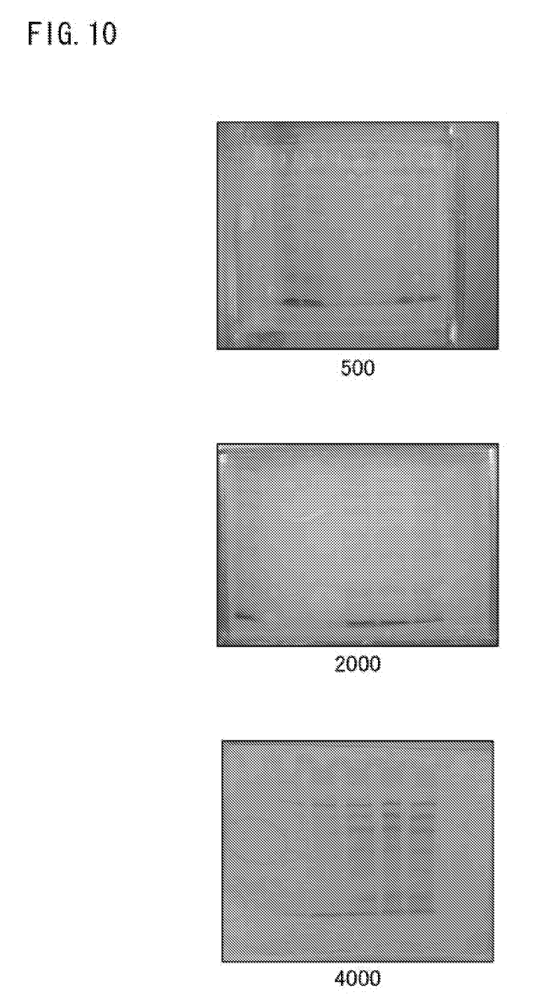

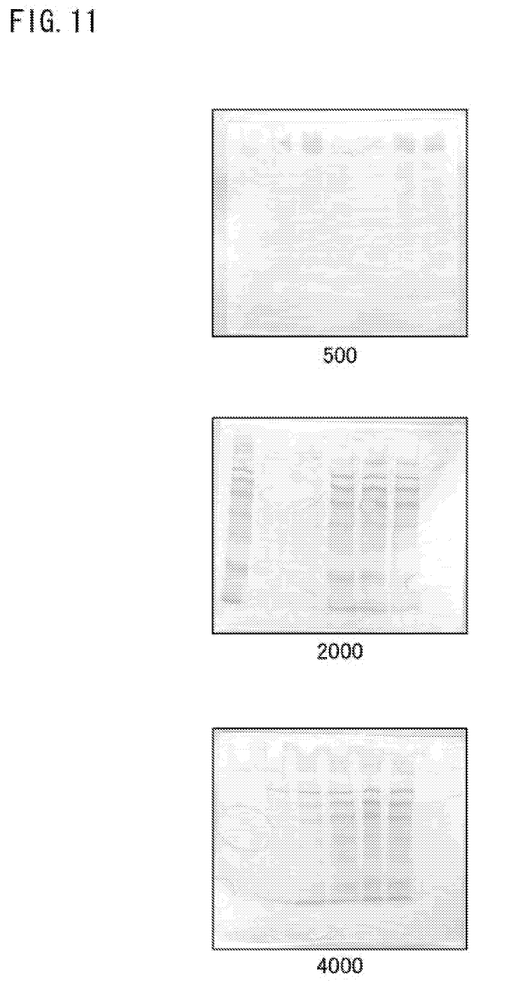

Studies on a polymerization degree of PVA were conducted. Chips for electrophoresis and transfer were formed, respectively, by use of PVDF membranes that were impregnated with solutions each containing PVA with different polymerization degrees. Stained markers were electrophoresed and transferred to the membranes. PVA solutions used in experiments contained 5% by weight of PVAs of Resin 1 through 3, respectively. Results were shown in FIGS. 10 and 11. FIG. 10 shows electrophoretic gels that were electrophoresed, and FIG. 11 shows PVA coated membranes to which samples were transferred from the gels that had been electrophoresed. FIGS. 10 and 11 show results of cases where, sequentially from the upper side of the figure, Resin 1 (polymerization degree 500), Resin 2 (polymerization degree 2000), and Resin 3 (polymerization degree 4000) were used.

As shown in FIGS. 10 and 11, in the case where PVA with polymerization degree of 500 was used, that made some effects on electrophoresis, with the result that it was difficult to obtain clear electrophoretic pattern and to detach the membranes from the electrophoretic gels (on the upper side of the figures). Meanwhile, in the cases where PVAs with polymerization degrees of 2000 and 4000 were used, any effects on electrophoresis were not caused, so that the markers were developed in the electrophoretic gels without any problems (the one in the center and the one on the downside of FIG. 10). Further, separation patterns of the markers were transferred to the membranes without any problems (the one in the center and the one on the downside of FIG. 11), and the membranes could be detached from the gels.

(2-9. Concentration of PVA)

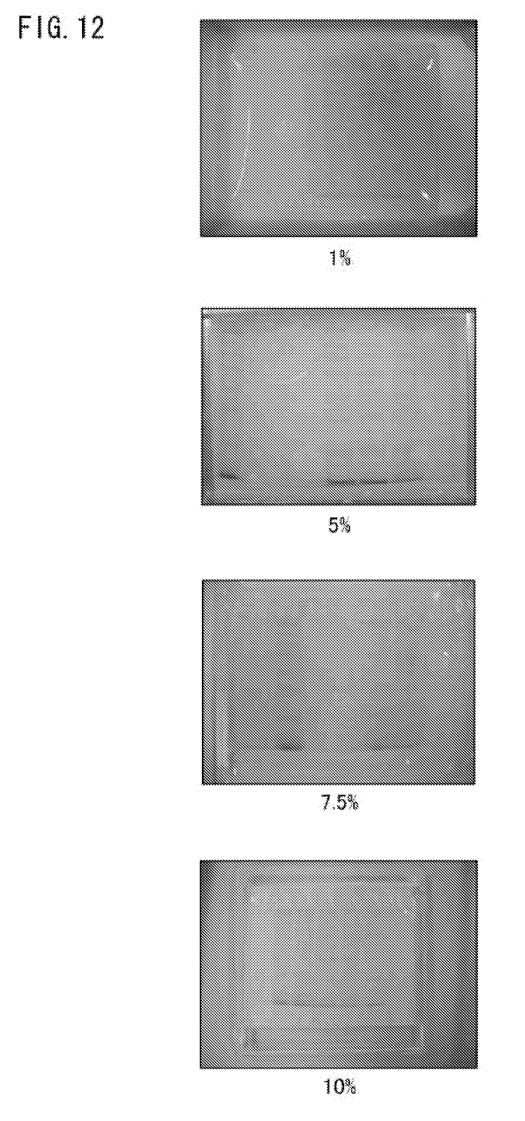

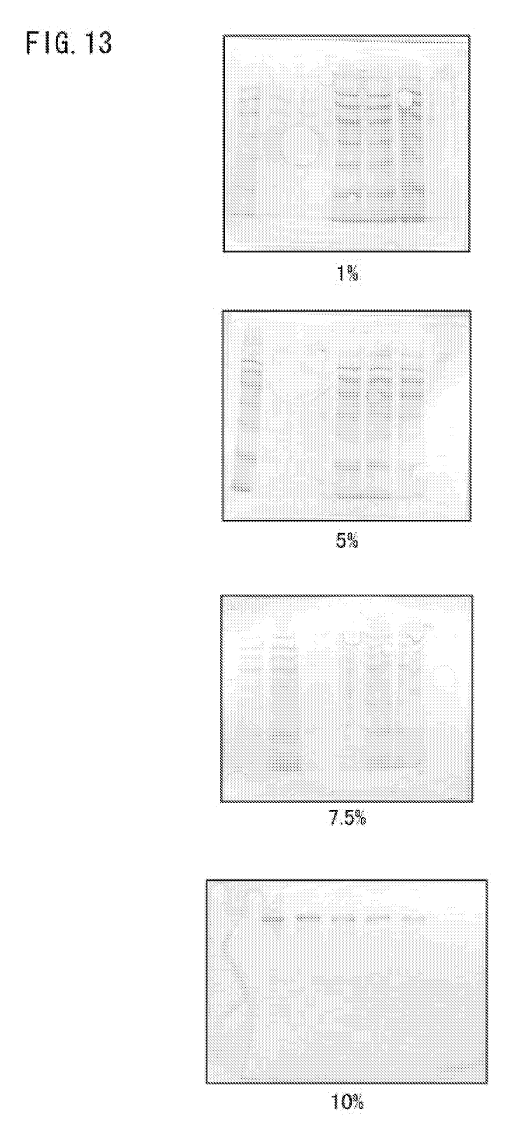

Studies on a concentration of PVA were conducted. Chips for electrophoresis and transfer were formed, respectively, by use of PVDF membranes that were impregnated with solutions containing PVA with different concentrations. Stained markers were electrophoresed and transferred to the membranes. Concentrations of PVA contained in the solutions used in experiments were, respectively, 1% by weight, 5% by weight, 7.5% by weight, and 10% by weight. Results are shown in FIGS. 12 and 13. FIG. 12 shows electrophoretic gels that were electrophoresed, and FIG. 13 shows PVA coated membranes to which samples were transferred from the gels that had been electrophoresed. FIGS. 12 and 13 show results of the cases with the use of PVA solutions of, sequentially from the above, 1% by weight of PVA, 5% by weight of PVA, 7.5% by weight of PVA, and 10% by weight of PVA.

As shown in FIGS. 12 and 13, in the case where the solution whose PVA concentration was 1% by weight was used, a fine electrophoresis pattern was obtained and transfer could be carried out without any problems. However, the membrane could not be detached from the gel. In the cases where the solutions whose PVA concentrations were 5% by weight and 7.5% by weight, electrophoresis and transfer could be successfully carried out, and the membranes could be detached from the gels. In the case where the solution whose PVA concentration was 10% by weight, the marker was separated by electrophoresis, but its separation pattern was rather broad.

According to the present invention, a transfer medium is integrated with an electrophoresis support. On this account, with the use of the present invention, it is not required to attach the transfer medium to the electrophoresis support that has been electrophoresed when a target material separated by electrophoresis is transferred to the transfer membrane. Consequently, this avoids troubles that are caused when the electrophoresis support is taken out from an electrophoresis apparatus and attached to the transfer medium, and further makes it possible to accurately transfer a separation pattern of the target material to the transfer medium.

With the use of the present invention, it is possible to more easily carry out processes of separating molecules by electrophoresis and transferring the separated molecules, and the present invention can be applied to an apparatus that consecutively carries out electrophoresis and transfer. Consequently, this develops further studies on biopolymers such as DNA, RNA, protein, and the like, which especially can contribute to development in industries of medical science, biology, and chemical field.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. A multilayer body for electrophoresis and transfer comprising:
a transfer medium; and
an electrophoresis support that is integrated with the transfer medium.

2. The multilayer body for electrophoresis and transfer as set forth in claim 1, wherein:
the transfer medium is a polyolefin porous membrane that contains a polyolefin resin as its main component.

3. The multilayer body for electrophoresis and transfer as set forth in claim 2, wherein:
the polyolefin resin is selected from the group consisting of polyethylene, polypropylene, poly(α-olefin), modified polyethylene, and modified polypropylene.

4. The multilayer body for electrophoresis and transfer as set forth in claim 2, wherein:
the polyolefin porous membrane is a coated membrane that is coated with nitrocellulose.

5. The multilayer body for electrophoresis and transfer as set forth in claim 4, wherein:
the coated membrane is impregnated with the nitrocellulose.

6. The multilayer body for electrophoresis and transfer as set forth in claim 4, wherein:
the coated membrane is hydrophilized.

7. The multilayer body for electrophoresis and transfer as set forth in claim 2, wherein:
the polyolefin porous membrane is in a range of 0.2 to 0.5 μm in pore diameter.

8. The multilayer body for electrophoresis and transfer as set forth in claim 1, wherein:
the transfer medium is a coated membrane that is coated with a water-soluble resin.

9. The multilayer body for electrophoresis and transfer as set forth in claim 8, wherein:
the coated membrane is impregnated with the water-soluble resin.

10. The multilayer body for electrophoresis and transfer as set forth in claim 8, wherein:
the water-soluble resin is a water-soluble polymer, a polysaccharide, or a protein, the water-soluble polymer being synthesized from polyvinyl alcohol (PVA), polyacrylic acid, polymethacrylic acid, polyvinyl amine, polyallylamine, or the like, the polysaccharide being starch, cellulose derivative, pectin, alginic acid, agarose, pullulan, or the like, and the protein being gelatin or the like.

11. The multilayer body for electrophoresis and transfer as set forth in claim 8, wherein:
the coated membrane is a membrane coated with the water-soluble resin, the membrane being selected from the group consisting of a polyvinylidene fluoride (PVDF) membrane, a nitrocellulose membrane, a polyolefin membrane, a polycarbonate membrane, a polyethersulfone membrane, a cellulose mixed ester membrane, a cellulose acetate membrane, and a polytetrafluoroethylene membrane.

12. The multilayer body for electrophoresis and transfer as set forth in claim 8, wherein:
the coated membrane is a hydrophilized membrane coated with the water-soluble resin.

13. A chip for electrophoresis and transfer comprising a multilayer body for electrophoresis and transfer as set forth in claim 1.

14. An electrophoresis and transfer apparatus that electrophoreses and transfers a target material to be separated, by use of a multilayer body for electrophoresis and transfer as set forth in claim 1,
said apparatus comprising:
separation means for separating the target material on the electrophoresis support; and
transfer means for transferring the target material thus separated on the electrophoresis support to the transfer medium.

15. A method for electrophoresing and transferring a target material to be separated, by use of a multilayer body for electrophoresis and transfer as set forth in claim 1,
said method comprising the steps of:
(a) separating the target material on the electrophoresis support; and
(b) subsequently to the step (a), transferring the target material thus separated on the electrophoresis support to the transfer medium.

16. The method as set forth in claim 15, further comprising the step of:
(c) detaching the transfer medium to which the target material has been transferred, from the electrophoresis support.

17. A method for manufacturing a multilayer body for electrophoresis and transfer as set forth in claim 1, comprising the step of:
forming the electrophoresis support by filling a material of the electrophoresis support onto the transfer medium.

18. The method as set forth in claim 17, further comprising the step of:
precedently to the step of forming the electrophoresis support, preparing the transfer medium by immersing a polyolefin porous membrane containing a polyolefin resin as its main component into a solution containing 0.5 to 3 mg/ml of nitrocellulose.

19. The method as set forth in claim 17, further comprising the step of:
precedently to the step of forming the electrophoresis support, preparing the transfer medium by immersing a membrane into a solution containing 5 to 7.5% by weight of a water-soluble resin.

20. An electrophoresis and transfer apparatus that electrophoreses and transfers a target material to be separated, by use of a chip for electrophoresis and transfer as set forth in claim 13,
said apparatus comprising:
separation means for separating the target material on the electrophoresis support; and
transfer means for transferring the target material thus separated on the electrophoresis support to the transfer medium.

21. A method for electrophoresing and transferring a target material to be separated, by use of a chip for electrophoresis and transfer as set forth in claim 13,
said method comprising the steps of:
(c) separating the target material on the electrophoresis support; and
(d) subsequently to the step (a), transferring the target material thus separated on the electrophoresis support to the transfer medium.
